(19) United States
(12) Patent Application Publication
(10) Pub. No.: US 2004/0008920 A1
(43) Pub. Date: Jan. 15, 2004

(54) Optically sensed high density switch position sensor

(76) Inventor: Eric Endicott, Lake Mary, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/430,915

(22) Filed: May 8, 2003

Related U.S. Application Data
(60) Provisional application No. 60/396,403, filed on Jul. 15, 2002.

(51) Int. Cl. G02B 6/42

(52) U.S. Cl. 385/12; 385/88

(57) ABSTRACT

An optical sensing system for optically detecting high density sensor inputs. The sensing system includes a sensor having a reflective portion for reflecting light in a desired direction corresponding to a condition of the sensor. The system also includes an optical fiber for receiving light from an illumination source and directing a light signal at the sensor. The light signal is reflected from the sensor according to the sensor's position and optically coupled through the optical fiber to a detector that detects an intensity of the reflected light signal transmitted through the optical fiber in response to the position of the sensor. In one form, the sensor is a switch having a reflective coating that reflects light in a desired direction corresponding to the position of the switch. In another form, the detector is a CCD for receiving many reflected light signals, each signal coupled to a respective pixel of the CCD.

### SPECIFIC DATA RELATED TO THE INVENTION

This application claims the benefit of U.S. provisional application, Application No. 60/396,403 filed Jul. 15, 2002, incorporated herein by reference.

### FIELD OF THE INVENTION

The present invention is directed to an optical detector for sensing high density sensor outputs and, more particularly, to an optical means for sensing switch positions in high density switching applications.

### BACKGROUND OF THE INVENTION

Current technology for aircraft cockpit controls, flight simulator control systems, and manufacturing control systems utilize extensive numbers of switches to actuate various systems or features that may be present or used in each of the above systems and also use numerous sensors to detect various conditions. Each of these devices outputs a signal along a current conductor, typically a pair of copper conductors that transmit the status of a switch or other sensor to a computer or other type of device adapted to receive the multiple inputs from the various switches or sensors. In the aircraft environment, the number of switches and sensors in a cockpit is extensive and the cabling for such device conditions typically comprises wire bundles that may be multiple inches in diameter. Each of these devices is typically monitored by an electrical system that determines the condition of the device and causes actuation of some system to control some feature in the aircraft. In a simulator environment, switches and operator controls may not be connected to operative equipment, but may instead be monitored, such as electrically, to determine the current condition of the switch or control, and the condition may be provided to an input/output (I/O) system for generating a simulated response corresponding to the switch or control input. However, such a system may require a large number of conductors connecting each switch or control to electronic circuits for interpreting the switch or control condition and providing an appropriate signal to control the simulator. Other problems with conventional switching technology include the weight of the conductors for wiring the switches, relatively high power requirements, EMI susceptibility, complicated electronics for monitoring the switches, corrosion susceptibility, relatively high heat production, electronic crosstalk between conductors, and difficult maintainability.

Accordingly, there is a need for a system that will reduce the volume of conductors and provide for a fast, reliable method of reading switch and sensor status.

### SUMMARY OF THE INVENTION

An optical sensing system is described herein as including a sensor having a reflective portion for reflecting light in a desired direction corresponding to a condition of the sensor. The system also includes an optical fiber having a illumination end for directing a light signal at the sensor and an illumination source, optically coupled to a coupling end of the optical fiber, for producing the light signal. The system further includes a detector, optically coupled to the coupling end of the optical fiber, for detecting an intensity of a reflected light signal transmitted from the coupling end of the optical fiber in response to a condition of the sensor. The system may also include a second optical fiber having a sensing end for receiving a reflected light signal from the sensor and an output end for transmitting the reflected light signal.

In addition, a method of optically determining a condition of a sensor is described herein as including directing a light signal at a selectively reflective sensor; and detecting an intensity of the light signal reflected from the sensor in response to the condition of the sensor.

### BRIEF DESCRIPTION OF THE DRAWINGS

The features of the invention believed to be novel are specifically set forth in the appended claims. The features and advantages of the present invention will become apparent from the following detailed description of the invention when read with the accompanying drawings in which:

FIG. 1 illustrates a switch position sensor system using a fiber optic, a reflective switch, and a detector.

FIG. 2 illustrates a switch position sensor system using a single transmit and feed fiber optic array.

FIG. 3 illustrates a switch position sensor system in which input light is transmitted at an angle to a single fiber optic array and reflected light from the fiber optic array is projected at different angle to a detector.

FIG. 4 illustrates a switch position sensor system including a feed optic fiber array and a sensing optic fiber array.

FIG. 5A illustrates a switch position sensor system incorporating an semiconductor light source.

FIG. 5B is an exploded view of the switch position sensor system of FIG. 5A.

### DETAILED DESCRIPTION OF THE INVENTION

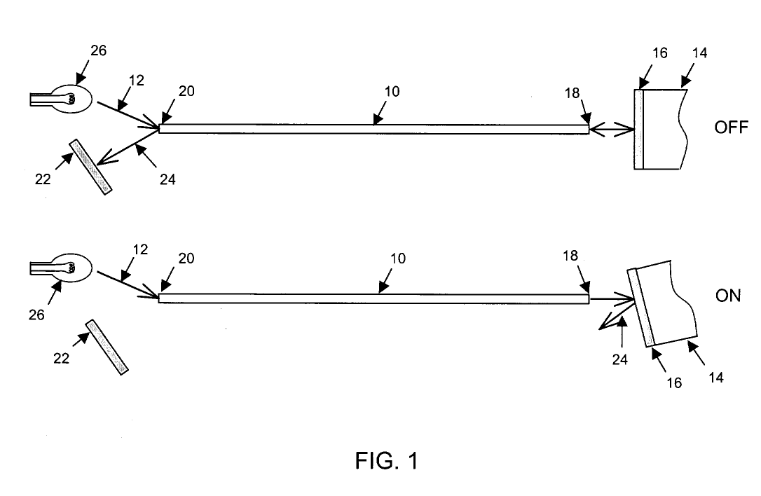

The present invention is directed to a system that utilizes optical fibers as conductors and light as the medium for determining status of switches and sensors. In one form, as depicted in FIG. 1, the system utilizes an optical fiber 10 to direct an optical signal 12 produced by a light source 26 to an individual switch 14 for sensing the optical signal 12 received at a sensing end 18 of the fiber 10. In an aspect of the invention, the switch 14 includes a means for changing the reflectivity, such as a retro-reflective coating 16 on the back of the switch 14 to reflect the optical signal 12 away from or into the sensing end 18 of the fiber 10, depending on the position of the switch 14. At a coupling end 20 of the fiber 10, a charge coupled device (CCD) 22 or other type of light intensity sensing device scans the ends of a plurality of such fibers 10 and determines the status of the associated switch 14 or sensor by the amount of light that is reflected back through the fiber 10 and impinges the sensing device, or CCD 22. The status of the switches can than be further processed to provide appropriate control actions. For example, as shown in FIG. 1, when the switch 14 is positioned in an “OFF” position, the retro-reflective coating 16 on the back of the switch 14 reflects the optical signal 12 back through the optical fiber 10 to the CCD 22 for detection. Accordingly, the intensity of the reflected light 24 detected at a specific location, such as a pixel or group of adjacent pixels of the CCD 22, is correlated to a specific fiber and the received intensity processed to determine that the switch 14 is off. When the switch 14 is in an “ON” position, the optical signal 12 is reflected away from the sensing end 18 of the fiber 10 so that little or no reflected light 24 is conducted to the CCD 22. Accordingly, a relatively reduced or no light intensity for the sensed switch 14 is detected by the CCD 22, indicating, for example, that the switch 14 is in a different position compared to a condition when a relatively higher intensity of reflected light 24 is detected, such as when the switch is in the “ON” position. While a switch 14 is depicted in FIG. 1, any control device as known in the art may be adapted for use with the invention, for example, by configuring the device so that the device reflects or deflects light corresponding to a condition of the device.

In an aspect of the invention, multiple fibers 10, for example, arranged in a two dimensional array at coupling ends of the fibers, are used to sense multiple respective switches 14. Each fiber 10 is coupled at its coupling end 20 to an area of the CCD 22. In a further aspect of the invention, the individual fibers 14 can be glued or mechanically held in place in, for example, a bundled, two-dimensional array so that the CCD 22 will be able to read the position of thousands of input devices, such as switches 14, simultaneously. Once the CCD 22 reads the switch 14 positions in a scan, the information obtained by the scan can be sent to a computer system (not shown) for decoding. Decoding the output of the CCD 14 may require averaging the pixels that contain information for particular input device and then storing the resulting information in an array for use by a higher-level control program. It is believed that a single CCD 14 having a 640 by 480 pixel array may control in excess of 300,000 input devices. However, the number of actual devices may be reduced by the amount of redundancy that may be required by any particular system, or if more than one pixel is used to detect the light intensity coming from a respective fiber.

The advantages of the optical fiber and CCD arrangement over existing electrically wired input-output systems is that the optical system has less weight, requires lower power, is EMI proof, has simplified electronics, is corrosion resistant, can be made waterproof, can have simple redundancy, produces less heat and requires less cooling, may be less expensive, eliminates electronic crosstalk between conductors, is easier to construct, has increased reliability, has decreased repair time, and can be arranged in higher density configurations.

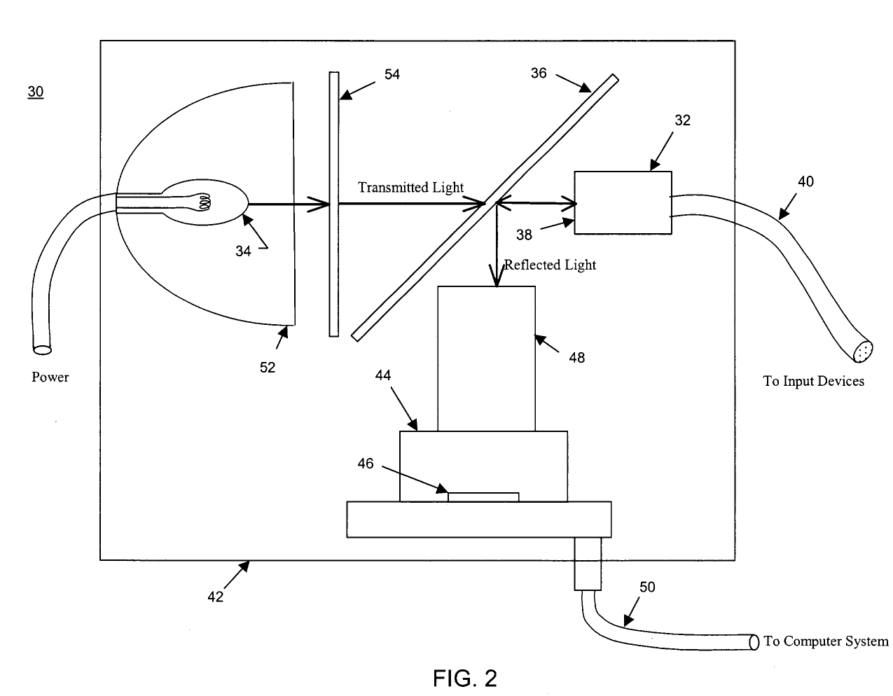

FIG. 2 illustrates a switch position sensor system 30 layout using a single transmit and feed fiber optic array 32 in which a light source 34 directs light through a beam splitter 36, or one-way mirror, onto fiber ends 38 in the fiber optic array 32. The light source 34 may further include a reflector 52 and a heat shield 54. The fibers 40 in the fiber optic array 32 are optically coupled to the various switches and sensor devices (not shown) so that the light directed onto the fiber ends is absorbed or reflected according to the position of the sensed switch or control. Light reflected by the switches is coupled back into the fibers 40 and directed into the system housing 42, where the reflected light from each fiber 40 is directed back to the beam splitter 36 and reflected, for example, at 90 degrees onto an optical sensor 44. The optical sensor may include a CCD 46 and associated optical elements 48, such as focusing lenses. The CCD 46 can then scan all of the fiber optic signals being returned and provide electrical signals via an interface connection 50 to a computer system (not shown) for detecting the status of each of the switching devices and sensors.

The light source 34 may be any of the well known light producing devices for use with optical fibers including incandescent, fluorescent, or high intensity discharge lighting elements. In addition, the light source may be a semiconductor light source, such as a light emitting diode (LED), or laser semiconductor, such as a side emitting or surface emitting laser semiconductor. Further, the beam splitter 36 used with the light source 34 may be constructed of glass or plastic, or other forms of focusing light may be used to direct light into the fiber optic array. Depending on the type of light source 34 that is used to direct light into the fiber optic array 32, the light may be filtered to remove excessive heat, or the fibers 40 may be incorporated with some form of heat sink to absorb heat. Typically, the heat input to the fibers 40 is minimized by moving the focal point of the light to a point in front of the fibers ends 38 so that the light is not focused at the fiber ends 38.

While the embodiments described herein suggests that a broadband light may be used for the invention, it will be apparent that a narrow frequency beam such as a laser beam may be an alternate type of light that could be used for this invention. Further, with a broadband light, an optical multiplexer could also be incorporated to separate the light into various wave lengths that are applied to different sets of optical fibers in order to isolate different fiber bundles. Further, while a CCD has been shown as a form of a detector, other forms of detectors may also be utilized within the scope of the invention. Still further, the particular array of the optical fibers within the optical fiber holder may take various configurations and shapes depending upon the particular application and the manner in which it is desired to organize and arrange the optical fibers so as to be able to detect the particular switch or sensor being monitored.

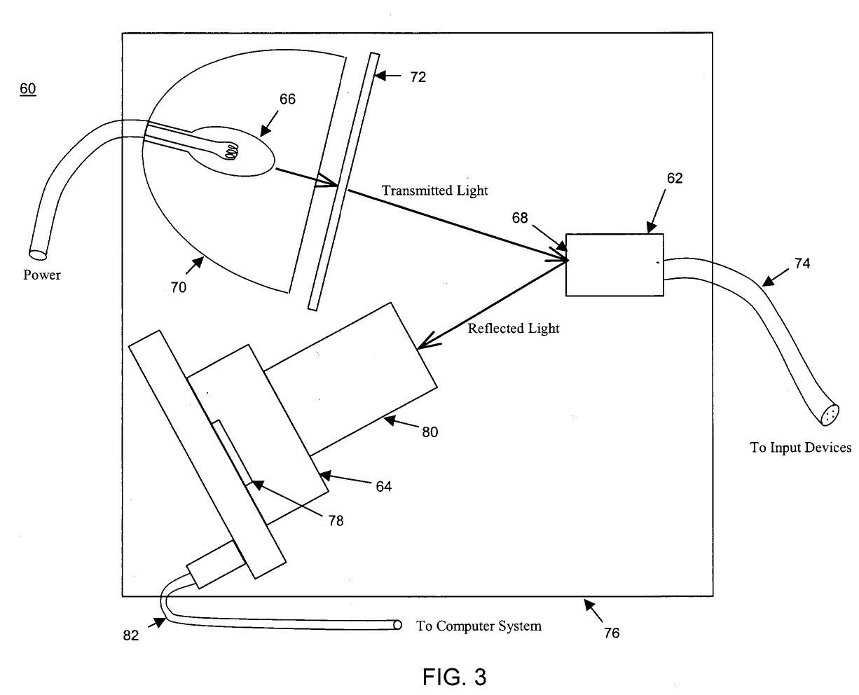

FIG. 3 illustrates a switch position sensor system 60 in which input light is transmitted at an angle to a single fiber optic array 62 and reflected light from the fiber optic array is projected at different angle to a detector 64. This embodiment uses common fibers for transmitted and reflected light. A light source 66, aligned at an angle, such as 15 degrees, with respect to a longitudinal axis of the detector 64, directs light into fiber ends 68 of the fiber optic array 62. The light source 66 may further include a reflector 70 and a heat shield 72. The fibers 74 in the fiber optic array 62 are then optically coupled to the various switches and sensor devices (not shown) so that the light directed onto the fiber ends 68 is absorbed or reflected according to the position of the sensed switch or control. Light reflected by the switches is coupled back into the fibers 74 and directed through the system housing 76, where the reflected light from each fiber 74 is directed into the detector 64, angularly positioned with respect to a light aiming axis of the light source 66. The detector 64 may include a CCD 78 and associated optical elements 80, such as focusing lenses. The CCD 78 can then scan all of the fiber optic signals being reflected and provide electrical signals via an interface connection 82 to a computer system (not shown) for detecting the status of each of the switching devices and sensors.

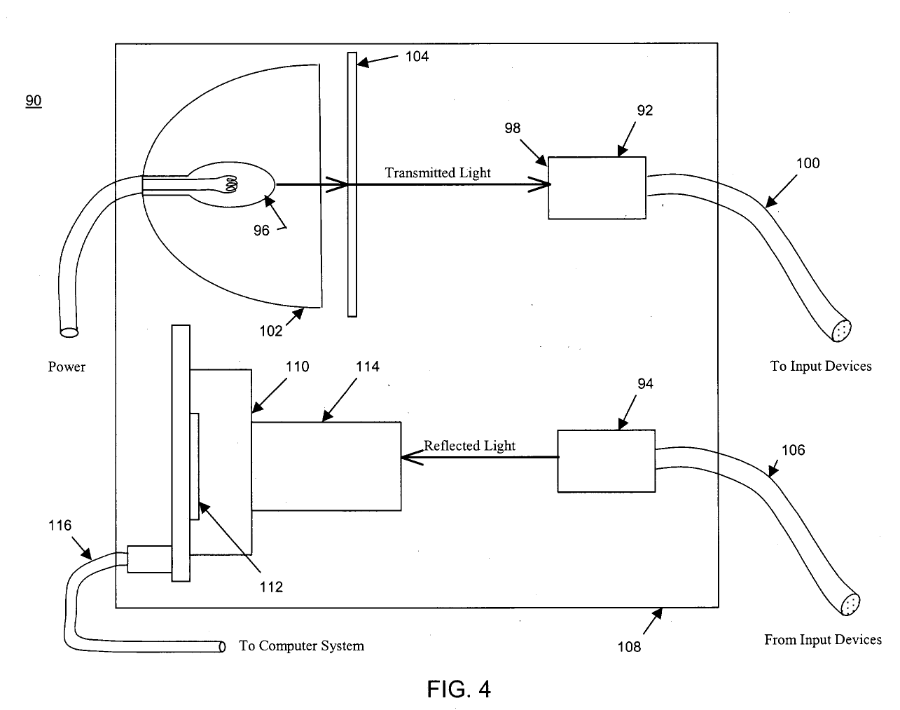

FIG. 4 illustrates a switch position sensor system 90 including a feed optic fiber array 92 and a sensing optic fiber array 94. A light source 96, directs light into fiber ends 98 of the feed fiber optic array 92. The light source 66 may further include a reflector 102 and a heat shield 104. The feed fibers 100 in the feed fiber optic array 92 are then optically coupled to the various switches and sensor devices (not shown) so that the light directed into the fiber ends 68 is reflected according to the position of the sensed switch or control. In addition, sensing fibers 106 are also optically coupled to the various switches and sensor devices. Light directed at the switches from the respective feed fibers 100 and reflected by the switches is coupled back into the associated sensing fibers 106 and directed through the system housing 108 and into the detector 110. The detector 110 may include a CCD 112 and associated optical elements 114, such as focusing lenses. The CCD 112 can then scan all of the fiber optic signals being returned and provide electrical signals via an interface connection 116 to a computer system (not shown) for detecting the status of each of the switching devices and sensors.

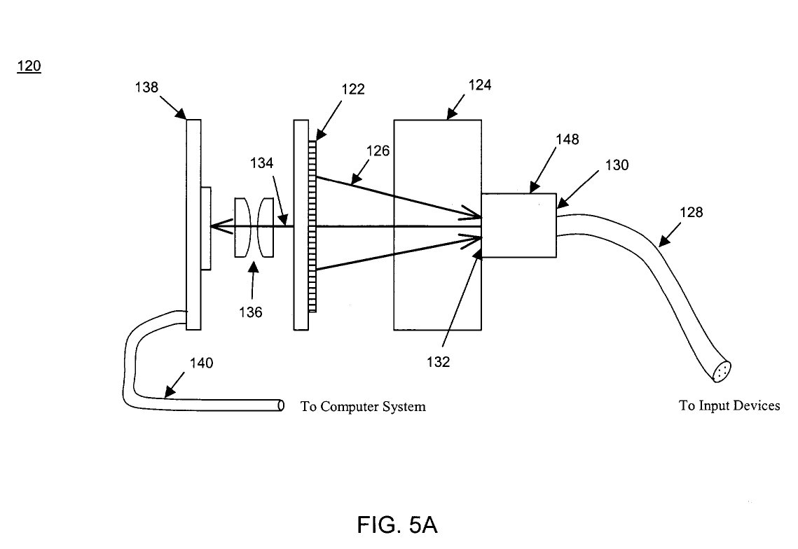

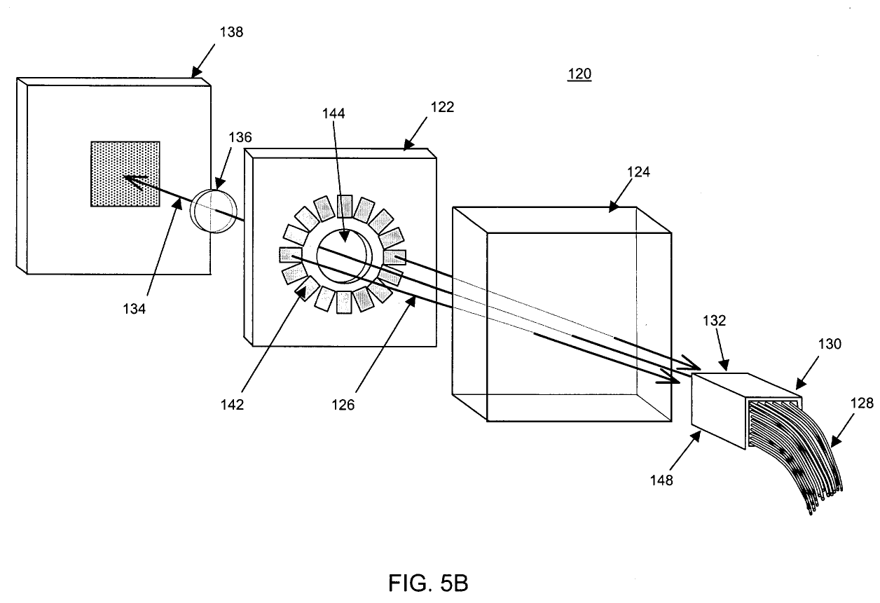

FIG. 5A illustrates a switch position sensor system 120 incorporating a semiconductor light source, such as an LED array 122. The LED array 122 directs light 126 through an optical coupling block 124, such as an acrylic cube, onto fiber ends 132 in the fiber optic array 130. The fibers 128 in the fiber optic array 130 are then optically coupled to the various switches and sensor devices (not shown) so that the light 126 directed onto the fiber ends 132 is absorbed or reflected according to the position of the sensed switch or control. Light reflected by the switches is coupled back into the fibers 128 and directed through the optical coupling block 124, the LED Array 122 (which may include an aperture for passing the reflected light 134), and optional lens 136 to a CCD 138. The CCD 136 can then scan all of the fiber optic signals being returned and provide electrical signals via an interface connection 140 to a computer system (not shown) for detecting the status of each of the switching devices and sensors.

FIG. 5B is an exploded view of the switch position sensor system 120 of FIG. 5A. In an aspect of the invention, the LED array 122 may include a plurality of LED's 142 positioned circumferentially around a central aperture 144. The aperture allows reflected light 134 from the fiber ends 132 to pass unimpeded from the optical coupling block 124 through the LED array 122 onto the CCD 138. Accordingly, the LED array 122 can direct light 126 through an optical coupling block 124 onto fiber ends 132, while allowing reflected light 134 to impinge on the CCD 134.

In an aspect of the invention, the individual LEDs 142 in the array may have a 15 degree viewing angle off-axis from a central axis as is known in the art. In addition, the LEDs 142 may be positioned in the LED array 122 such that the central axis of the LED is inclined (for example, by 15 degrees from a normal to the plain of the array) to point towards a center of the aperture 144, to concentrate the light 126 onto the fiber ends 132. The optical coupler 124, such as a clear acrylic block, also serves to eliminate reflections inherent when shining light directly on the fiber ends 132. Accordingly, any reflection due to a change in refractive index of the light emitted from the LEDs 142 will occur at the face of the LEDs 142 abutting the optical coupler 124 rather than the fiber ends 132, so the reflected light 134 emitted from the fiber ends 132 represents only the reflected light 134 from the switches, and does not include a component of light reflected from the fiber ends 132 themselves. For example, the fiber ends 132 may be adhered to a face of the optical coupler 124 with an optical room temperature vulcanizing (RTV) compound that has index of refraction matching the fiber's 128 index of refraction so that reflection is minimized between the fiber ends 132 and the optical coupler 124.

In one form of the invention, 0.020 inch (0.051 cm) diameter fibers 128 can be used, allowing approximately 5000 fibers 128 to be arranged in a two-dimensional array at the fiber ends, such as a square having a 1.4 inch (3.56 cm) side, and held in place by a collar 148. LEDs 142, mounted in a ring configuration around a central aperture and having a dispersion angle of 15 degrees, can then illuminate all the fiber ends 132 in the fiber array 130 through the optical coupler 124. A lens assembly 136 can be provided to align the reflected light 134 emitted from the fiber ends 132 through the aperture with respective individual pixels on the CCD 138. Consequently, different fiber array 130 configurations would require different lens assemblies to ensure the focal area of the reflected light 134 on the CCD 138 is aligned with the desired individual pixels on the CCD 138. In an aspect of the invention, if more fibers 128 are desired than can be accommodated with an existing lens assembly 146, the thickness of the optical coupler 124 can be increased, thereby increasing the focal length of the lens assembly 146 and allowing all the reflected light 134 emitted by the fiber ends 132 to be projected on the CCD 138.

While only certain preferred features of the invention have been shown by way of illustration, many modifications and changes will occur to those skilled in the art. It is, therefore, to be understood that the present claims are intended to cover all such modifications and changes, which fall within the true spirit of the invention.

What is claimed is:

1. An optical sensing system comprising:
a sensor comprising a reflective portion for reflecting light in a desired direction corresponding to a condition of the sensor;
an optical fiber having an illuminating end for directing a light signal at the sensor;
an illumination source, optically coupled to a coupling end of the optical fiber, for producing the light signal; and
a detector, optically coupled to the coupling end of the optical fiber, for detecting an intensity of a reflected light signal transmitted from the coupling end of the optical fiber in response to a condition of the sensor.

2. The system of claim 1, the detector further comprising a plurality of addressable light sensors, at least one of the light sensors optically coupled to the coupling end of a respective optical fiber.

3. The system of claim 1, wherein the detector is a charge coupled device.

4. The system of claim 1, the illumination source further comprising a semiconductor light source.

5. The system of claim 4, wherein the semiconductor light source is a light emitting diode or a laser semiconductor.

6. The system of claim 4, wherein the semiconductor light source further comprises an array of semiconductor light sources configured for illuminating the coupling end of the optical fiber and allowing passage of the reflected light signal through the array.

7. The system of claim 6, wherein the array comprises a circular pattern having a central aperture for allowing passage of the reflected light signal.

8. The system of claim 4, further comprising an optical coupler for coupling the light signal produced by the illumination source to the coupling end of the optical fiber.

9. The system of claim 4, further comprising a lens for focusing the reflected light emitted from the coupling end of the optical fiber at a desired portion of the detector.

10. The system of claim 1, further comprising a beam splitter for transmitting the light signal to the coupling end of the optical fiber and reflecting the reflected light signal from the coupling end of the optical fiber to the detector.

11. The system of claim 1, further comprising a heat shield, mounted between the illumination source and the coupling end of the optical fiber for reducing heat transmitted to the coupling end of the optical fiber from the illumination source.

12. The system of claim 1, further comprising a refractive element for optically coupling the reflected light to the detector.

13. The system of claim 1, further comprising a plurality of optical fibers arranged in a two dimensional array at respective coupling ends and configured to illuminate a plurality of corresponding sensors at respective illumination ends.

14. An optical sensing system comprising:
a sensor comprising a reflective portion for reflecting light in a desired direction corresponding to a condition of the sensor;
a first optical fiber having an illuminating end for directing a light signal at the sensor;
an illumination source, optically coupled to an input end of the first optical fiber, for producing the light signal;
a second optical fiber having a sensing end for receiving a reflected light signal from the sensor and an output end for transmitting the reflected light signal; and
a detector, optically coupled to the output end of the second optical fiber, for detecting an intensity of the reflected light signal transmitted from the output end of the second optical fiber in response to a condition of the sensor.

15. The system of claim 14, the detector further comprising a plurality of addressable light sensors, at least one of the light sensors optically coupled to the output end of a respective optical fiber.

16. A method of optically determining condition of a sensor comprising:
directing a light signal at a selectively reflective sensor; and
detecting an intensity of the light signal reflected from the sensor in response to a condition of the sensor.

17. The method of claim 16, further comprising providing an illumination source for generating the light signal.

18. The method of claim 17, further comprising optically coupling a first end of an optical fiber to the illumination source and to the detector.

19. The method of claim 18, further comprising optically coupling a second end of the optical fiber to the sensor.
